(19) United States
(12) Patent Application Publication
(10) Pub. No.: US 2004/0242290 A1
(43) Pub. Date: Dec. 2, 2004

(54) Broadband communication system

(76) Inventor: Michael C. Keeling, Phoenix, AZ (US)

Correspondence Address: STONEMAN LAW OFFICES, LTD, 3113 NORTH 3RD STREET, PHOENIX, AZ, 85012, US

(21) Appl. No.: 10/855,171

(22) Filed: May 26, 2004

Related U.S. Application Data
(60) Provisional application No. 60/474,801, filed on May 29, 2003.

(51) Int. Cl. H04Q 7/20; H04B 7/185

(52) U.S. Cl. 455/575.1; 455/426.2; 455/466

(57) ABSTRACT

A broadband communication system which conceals broadband transceivers in architectural elements that appear to be standard stock architectural elements. It provides connectivity without negatively impacting aesthetics, and is easily integrated with the other systems and architectural features of a building.

### CROSS-REFERENCE TO RELATED APPLICATION

The present application is related to and claims priority from prior provisional application Ser. No. 60/474,801, filed May 29, 2003, entitled “BROADBAND COMMUNICATION SYSTEM”, the contents of which are incorporated herein by this reference and are not admitted to be prior art with respect to the present invention by the mention in this cross-reference section.

### BACKGROUND

This invention relates to providing improved systems for wireless electronic connectivity for local support of users with equipment having wireless communication ability. More particularly, it relates to providing such support for broadband connectivity.

There is currently a high demand for establishing broadband connectivity throughout buildings to provide access to voice, video and data. Providing connectivity by running cables directly to devices, such as personal computers and printers, can be cumbersome, especially when the devices may be relocated from time to time, thereby, e.g., requiring rerouting and/or adding new cables, etc.

Even wireless networks have drawbacks. Distributing and mounting transceivers throughout buildings can be problematic since the placement of an array of transceivers (and supplying them with power) would be best if fit in—aesthetically and functionally—with the other architectural features and systems of the building, such as HVAC, plumbing, other conduits, etc. Routing and placing such an array of transceivers in locations that do not interfere or conflict with other architectural features and building systems is difficult, especially if an existing building or structure (for which such an array was not anticipated) is being retrofitted. When aesthetics are taken into consideration (since such transceivers are typically unsightly), locating and placing such an array of transceivers throughout a building can add an extra degree of difficulty and result in further undesired limitations on where and how such transceivers are mounted to minimize unsightliness. Often, in the past, in order to provide adequate connectivity, unsightly transceivers have had to be installed in locations that detract from the aesthetics, etc., of the building.

### OBJECTS AND FEATURES OF THE INVENTION

A primary object and feature of the present invention is to provide a system that provides wireless broadband connectivity. It is a further object and feature of the present invention to provide such a system that is easily integrated with the other systems and architectural features of a building.

It is a further object and feature of the present invention to provide such a system that conceals broadband transceivers to provide connectivity without negatively impacting aesthetics.

It is a further object and feature of the present invention to provide such a system that can be efficiently installed in new building construction and also efficiently “retrofitted” into existing buildings.

It is a further object and feature of the present invention to provide such a system that allows broadband transceivers to “piggy-back” on the power distribution of other building systems.

It is a further object and feature of the present invention to provide such a system that conveniently allows great flexibility and adaptability in installation and customization, taking into consideration the requirements of the building, by utilizing modular components.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a broadband communication system, for locally supporting users with equipment having wireless communication ability in at least one area served by a plurality of similar-appearing stock fixtures, comprising, in combination: transceiver means for assisting wireless broadband communication by the users in the at least one area; and concealer means for substantially concealing such transceiver means from the users in the at least one area; wherein such concealer means comprises housing means for housing such transceiver means; wherein such housing means comprises substantially stock fixture means for serving the at least one area; and wherein such substantially stock fixture means comprises stock fixture subset means for providing at least one subset of the plurality of similar-appearing stock fixtures.

Moreover, it provides such a broadband communication system wherein such stock fixture means comprises lighting means for lighting the at least one area. Additionally, it provides such a broadband communication system further comprising building means for providing the at least one area. Also, it provides such a broadband communication system wherein such stock fixture means comprises lighting means for lighting the at least one area. In addition, it provides such a broadband communication system wherein such building means comprises network means for connection of such transceiver means with at least one network. And, it provides such a broadband communication system wherein such lighting means comprises at least one light bulb. Further, it provides such a broadband communication system wherein such transceiver means is structured and arranged to fit within the space of a standard ballast.

Even further, it provides such a broadband communication system wherein such transceiver means draws power from the power distribution network of the similar-appearing stock fixtures. Moreover, it provides such a broadband communication system further comprising display means for displaying transceiver status. Additionally, it provides such a broadband communication system further comprising display adapter means for adapting such display means to be more easily seen. Also, it provides such a broadband communication system wherein at least one single cable both carries data and provides power to such transceiver means.

In accordance with another preferred embodiment hereof, this invention provides a broadband communication system system comprising, in combination: at least one substantially stock lighting fixture; and housed within such at least one substantially stock lighting fixture, at least one transceiver structured and arranged to assist wireless broadband communication; wherein such broadband communication system is structured and arranged to be connected to at least one source of electrical power and at least one communication network. In addition, it provides such a broadband communication system wherein such transceiver is structured and arranged to fit within the space of a standard ballast. And, it provides such a broadband communication system wherein at least one single cable carries data and provides power to such at least one transceiver.

In accordance with another preferred embodiment hereof, this invention provides a method, for providing a combined product for use in a broadband communication system, for locally supporting users with equipment having wireless communication ability in at least one area served by a plurality of similar-appearing stock fixtures, comprising the steps of: selecting an existing manufacturer of such similar-appearing stock fixtures; selecting an existing manufacturer of transceivers structured and arranged to assist wireless broadband communication; and assisting implementation of at least one joint development project, including both such existing manufacturer of such similar-appearing stock fixtures and such existing manufacturer of transceivers structured and arranged to assist wireless broadband communication, to provide combined product. Further, it provides such a method further comprising the step of: using at least one at-least-partially-existing distribution channel of such existing manufacturer of such similar-appearing stock fixtures to distribute such combined product.

In accordance with another preferred embodiment hereof, this invention provides a broadband communication system, for locally supporting users with equipment having wireless communication ability in at least one area served by a plurality of similar-appearing stock fixtures, comprising, in combination: at least one transceiver to assist wireless broadband communication by the users in the at least one area; and at least one concealer adapted to substantially conceal such at least one transceiver from the users in the at least one area; wherein such at least one concealer comprises at least one housing to house such at least one transceiver; wherein such at least one housing comprises at least one substantially stock fixture adapted to serve the at least one area; and wherein such at least one substantially stock fixture comprises at least one subset of a plurality of similar-appearing stock fixtures.

Even further, it provides such a broadband communication system wherein such at least one substantially stock fixture comprises at least one illuminator adapted to light the at least one area. Even further, it provides such a broadband communication system further comprising at least one building adapted to provide the at least one area. Even further, it provides such a broadband communication system wherein such at least one stock fixture comprises at least one illuminator adapted to light the at least one area. Even further, it provides such a broadband communication system wherein such at least one building comprises at least one network structured and arranged to connect of such at least one transceiver within such at least one network. Even further, it provides such a broadband communication system wherein such at least one illuminator comprises at least one light bulb. Even further, it provides such a broadband communication system wherein such at least one transceiver is structured and arranged to fit within the space of a standard ballast.

Even further, it provides such a broadband communication system wherein such at least one transceiver is structured and arranged to draw power from a power distribution network of the similar-appearing stock fixtures. Even further, it provides such a broadband communication system further comprising at least one display adapter to permit ease of viewing of at least one display of transceiver status. Even further, it provides such a broadband communication system wherein at least one single cable both carries data and provides power to such at least one transceiver.

### BRIEF DESCRIPTION OF THE DRAWINGS

FIG. 1 is a perspective view of a broadband communication system according to a preferred embodiment of the present invention.

FIG. 2 is a partially cut-away bottom view of the broadband communication system of FIG. 1.

FIG. 3 is a section through the section 3-3 of FIG. 2, additionally showing a portion of ceiling in which the broadband communication system is installed.

FIG. 4 is a perspective view of a cut-away portion of the embodiment of FIG. 2.

FIG. 5 is a partially cut-away bottom view of a broadband communication system according to an alternate preferred embodiment of the present invention.

FIG. 6 is a sectional view through the section 6-6 of FIG. 5, additionally showing a portion of ceiling in which the broadband communication system is installed.

FIG. 7 is a perspective view of a portion of a building in which several different types of broadband communication systems are installed, according to preferred embodiments of the present invention.

FIG. 7A is a side view of a track lighting system showing three stock light fixtures and a broadband communication system according to a preferred embodiment of the present invention.

FIG. 8 is a simplified relational diagram of a preferred embodiment of the present invention, showing an example configuration of a broadband communication network.

FIG. 9 is a simplified relational diagram of a preferred embodiment of the present invention, showing a preferred method of providing a broadband communication system.

FIG. 10 is a simplified relational diagram of a preferred embodiment of the present invention, showing a preferred method of providing a broadband communication system.

### DETAILED DESCRIPTION OF THE BEST MODES AND PREFERRED EMBODIMENTS OF THE INVENTION

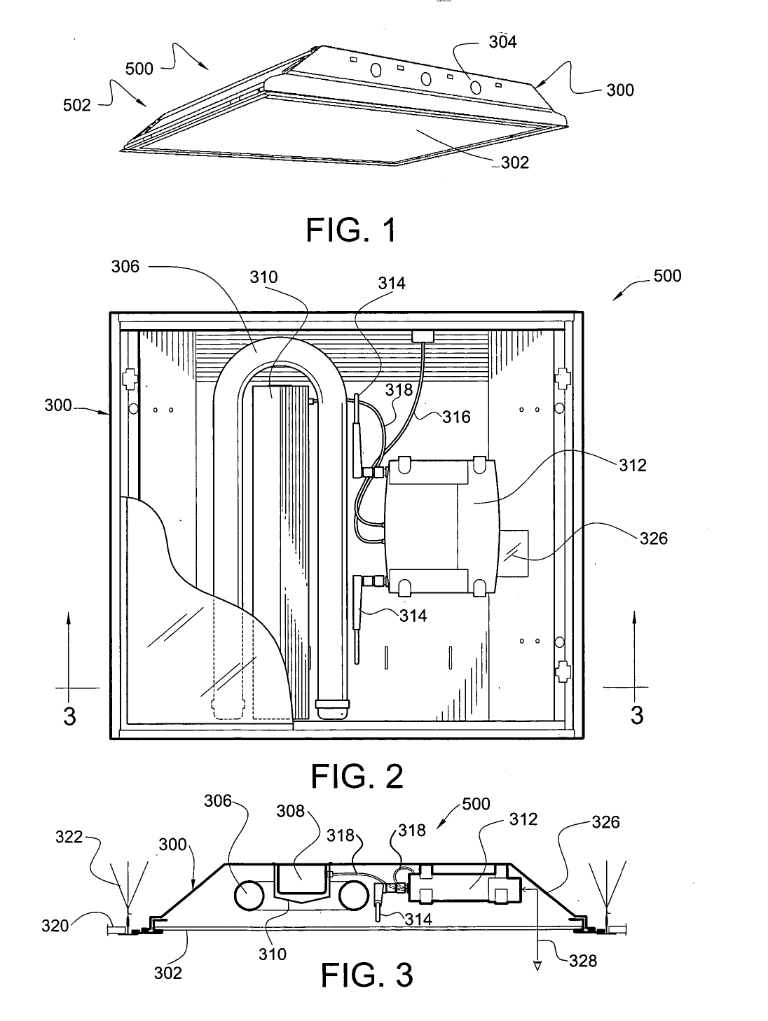

Preferably, with reference to the figures, in addition to functioning as a wireless broadband transceiver, broadband communication system unit 500 is structured and arranged to function, and appear from the exterior, identically to a stock architectural element (such as, for example, a lighting fixture 502, as shown in FIG. 1). Thus, broadband communication system unit 500 can efficiently and easily replace the stock architectural element in an existing building or structure. Likewise, broadband communication system unit 500 can be interspersed with stock elements without compromising a consistent and uniform appearance. For example, there may be ten lighting fixtures in a room arranged in two rows of five, seven of which are standard stock lighting fixtures 502 and three of which are broadband communication system units 500. Preferably, the three of broadband communication system units 500, functioning transparently as wireless broadband transceivers, appear and function as light fixtures identically to the other seven entirely stock lighting fixtures 502 (at least embodying herein wherein said substantially stock fixture means comprises stock fixture subset means for providing at least one subset of the plurality of similar-appearing stock fixtures).

Preferably, broadband communication system units 500 are spaced throughout at least one local area, e.g., a building, to provide sufficient broadband connectivity in areas where devices (such as computers) that utilize wireless connectivity may be placed. The present invention provides a convenient and aesthetically pleasing way to provide connectivity in a building by providing wireless broadband connectivity (for voice and/or data and/or video connectivity, etc.) which allows a great deal of flexibility in locating and rearranging the computers and other devices in the building. Preferably, broadband communication system unit 500 meets all typical specifications relating to the analogous stock element (e.g., element 502) which it is designed to replace, such as, for example, external dimensions, mounting arrangements, material strength, etc. It is noted that, throughout this specification, “replace” is intended to include placing a broadband communication system 500 unit in a location where no previous element has been (for example in new construction), as well as retrofitting by removing a stock architectural element (like 502) in exchange for a similar appearing broadband communication system unit 500. Preferably, broadband communication system 500 unit meets all fire-rating, environmental-rating and other installation requirements, etc., that would be required of the analogous stock element replaced, in addition to any requirements due to the fact that the broadband communication system unit 500 comprises a broadband transceiver. Preferably, broadband communication system unit 500 is provided in a variety of shapes, sizes, and styles, etc., corresponding to the different shapes, sizes, and styles, etc., of stock elements (such as, for example, light fixtures 502), thereby allowing an architect or interior designer, etc., flexibility in selection.

FIG. 1 is a perspective view of broadband communication system unit 500 according to a preferred embodiment of the present invention. Preferably, broadband communication system unit 500 comprises housing 300 and concealer 302, as shown. Preferably, housing 300 and concealer 302 are structured and arranged to match the standard specifications and requirements of a stock architectural element such as, for example, a recessed light fixture 502, as shown (at least embodying herein wherein said housing means comprises substantially stock fixture means for serving the at least one area). Preferably, concealer 302 is made of an appropriate material and adapted to allow efficient transmission of electromagnetic radiation used by transceiver for transmission and reception. Preferably, concealer 302 (at least embodying herein concealer means for substantially concealing said transceiver means from the users) is made of an appropriate material and adapted to allow proper functioning identical to the analogous stock fixture as well. For example, preferably, concealer 302 allows transmission of visible light similar to a stock lighting fixture 502, as shown. Preferably, broadband communication system unit 500 comprises a light fixture 502, as shown, for illuminating at least one room of a building (at least embodying herein wherein said stock fixture means comprises lighting means for lighting the at least one area).

In another preferred embodiment in which broadband communication system unit 500 functions as a speaker (not shown), concealer 302 preferably allows transmission of sound waves similarly to a stock speaker cover.

Preferably, housing 300 comprises knockouts 304 which allow flexibility in routing conduits for data and/or power transmission cables into and out of housing 300 of broadband communication system unit 500.

FIG. 2 is a partially cut-away bottom view of broadband communication system 500 unit structured and arranged to replace a stock recessed lighting fixture 502. Preferably, broadband communication system unit 500 comprises transceiver 312 (at least embodying herein transceiver means for assisting wireless broadband communication). Preferably, transceiver 312 comprises at least one antenna 314 for transmitting and receiving wireless signals. Preferably, transceiver 314 is a LINKSYS wireless router. Upon reading this specification, those skilled in the art will now understand that, under appropriate circumstances, considering such issues as improvements in technology and availability of different types of wireless transceivers, etc., other types of wireless transceivers may suffice, such as, for example, other brands of wireless transceivers, wireless transceivers utilizing other frequencies, wavelengths, transmission protocols, coding and encrypting methods, etc. Preferably, broadband communication system unit 500 comprises ballast 308 and bulb 306. Upon reading this specification, those skilled in the art will now understand that, under appropriate circumstances, considering such issues as the analogous type of stock architectural element being replaced, etc., other arrangements or similar architectural element features, such as for example, LEDs, incandescent bulbs, halogen bulbs, speakers, etc., may suffice.

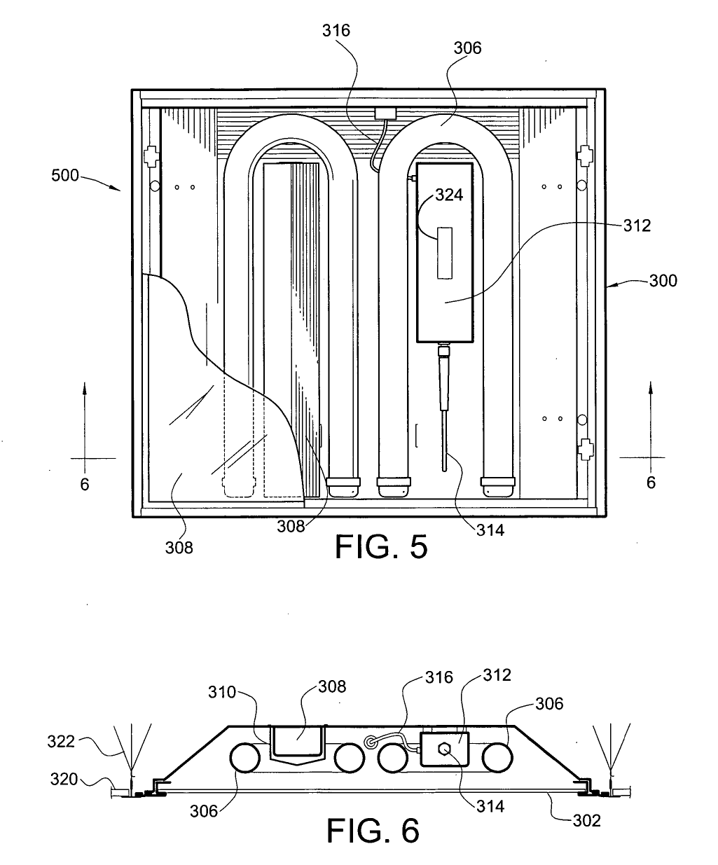

Preferably, broadband communication system unit 500 comprises shielding 310 to minimize any interference from the stock architectural element features (such as, for example, electromagnetic radiation or heat generated from ballast 308) that might interfere with efficient functioning of transceiver 312. Preferably, transceiver 312 comprises operation display 324, which gives a user information about the status of the transceiver, such as, for example, whether the transceiver is receiving power properly, etc. Preferably, broadband communication system 500 comprises display adapter 326 (at least embodying herein display adapter means for adapting such display means, for displaying transceiver status, to be more easily seen), such as a reflective mirror, as shown, which allows a user (such as an information technology maintenance worker) to more easily read operation display 324 (typically mounted on the side of transceiver 312 and therefore not shown in FIG. 2; also see FIG. 5) of transceiver 312, especially if transceiver 312 is mounted within housing 300 in such a way that operation display 324 would otherwise be difficult for a user to view. Upon reading the teachings of this specification, those skilled in the art will now appreciate that, under appropriate circumstances, considering such issues as cost to manufacture, varying transceiver mounting arrangements, different styles or sizes or shapes of housing, etc., other structures and arrangements of transceiver operation displays and display adaptors, etc., may suffice, such as, for example, remote displays, centralized displays, etc.

FIG. 3 is a sectional view through the section 3-3 of FIG. 2, additionally showing a portion of ceiling in which broadband communication system 500 is installed. Broadband communication system 500 may be installed flush with acoustic tile ceiling panels 320 held up by ceiling suspenders 322, as shown. Upon reading this specification, those skilled in the art will now understand that, under appropriate circumstances, considering such issues as the type of stock architectural element being replaced, etc., other installation techniques may suffice, such as, for example, techniques substantially identical to the installation techniques of the analogous architectural elements being replaced, such as bolting a broadband communication system to a wall, etc.

Preferably, transceiver 312 draws power through power cord 318 from the same power source that would otherwise provide power to the analogous element being replaced. Upon reading the teachings of this specification, those skilled in the art will now understand that, under appropriate circumstances, considering such issues as the type of stock architectural element being replaced, available power sources, etc., other power source arrangements may suffice, such as, for example, providing a battery for the transceiver that is periodically charged (e.g., by the power source for the stock architectural element or by manual periodic maintenance or replacement, etc.) or providing a separate source of power, etc. Preferably, data cable 316 allows transceiver 312 to be connected to a computer network or other broadband source in the building (at least herein embodying wherein said building means comprises network means for connection of said transceiver means with at least one network). Upon reading the teachings of this specification, those skilled in the art will now understand that, under appropriate circumstances, considering such issues as the accessibility of broadband source cables, installation cost, etc., other arrangements may suffice, such as, for example, omitting the cable connection to the transceiver and configuring the transceiver for completely wireless connection to the broadband source (e.g., the Internet), etc.

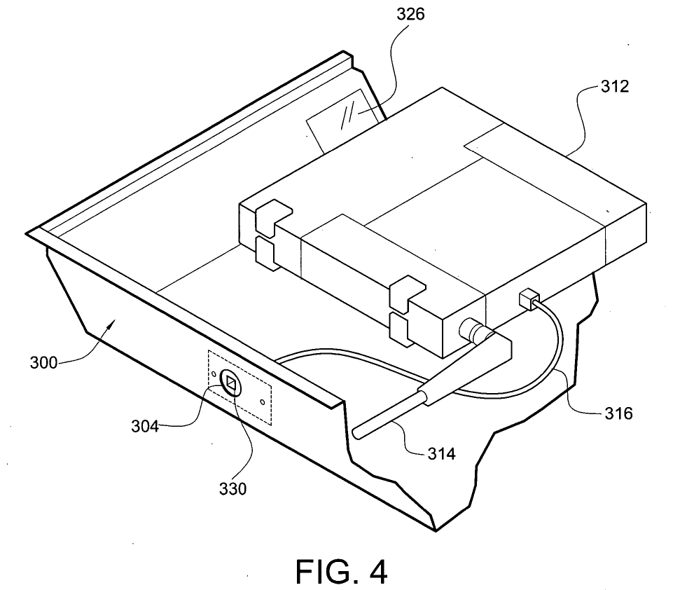

FIG. 4 is a perspective view of a cut-away portion of the embodiment of FIG. 2. Preferably, data cable 316 connects to adapter 330 that is mounted on housing 300, allowing cable connection (not shown) to an outside broadband source through knockout 304. Preferably, adapter 330 is a standard RJ-45 adapter to allow quick and convenient connection of transceiver 312 to an outside broadband source. Upon reading the teachings of this specification, those skilled in the art will now understand that, under appropriate circumstances, considering such issues as the type of stock architectural element being replaced, etc., other arrangements may suffice, such as, for example, omitting or using a different type of adapter, etc. In an alternate preferred embodiment of the present invention, data cable 316 and power cord 318 are combined in a single cable that may be connected to adapter 330, in which case some of the wires in the single cable carry data and at least one other wire provides power.

FIG. 5 is a partially cut-away bottom view of a broadband communication system 500 unit according to an alternate preferred embodiment of the present invention. Preferably, particularly in converting an existing light fixture 502 into a broadband communication system unit 500, transceiver 312 is structured and arranged to fit within the space otherwise occupied by a ballast, as shown in FIGS. 5 and 6. Preferably, operation display 324 is located on transceiver 312 in a location that allows a user to easily view operation display 324, as shown.

FIG. 6 is a sectional view through the section 6-6 of FIG. 5, additionally showing a portion of ceiling in which the broadband communication system is installed.

According to a preferred embodiment of the present invention, architects and interior designers, etc., will now be able to provide wireless broadband connectivity for a building by replacing a subset of stock architectural elements (such as a subset of lighting fixtures 502) with elements that appear identical to the replaced fixtures, but are, in fact, broadband communication system units 500, thereby simplifying the design and installation of broadband connectivity. In a preferred embodiment of the present invention, broadband communication system 500 unit can take advantage of the same cable routing that would otherwise be used to supply such stock fixtures with electrical power (simplifying installation by eliminating the need for independent routing).

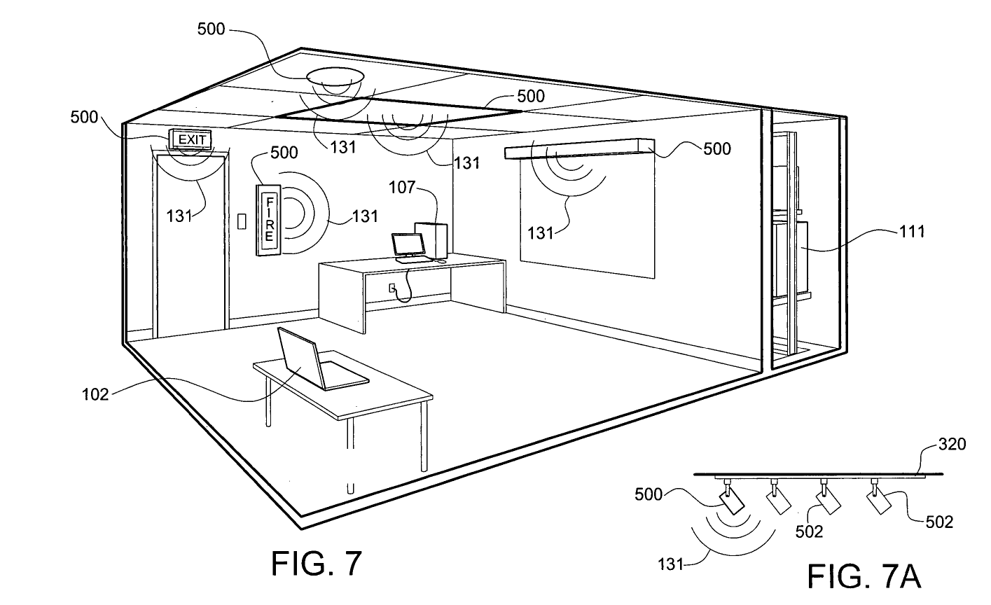

FIG. 7 is a perspective view of an area of a building showing examples of several different types of broadband communication system units 500 (replacing different types of architectural elements). Mobile computer 102 and desktop workstation 107 are connected to network server 111 via one or more wireless connections 131 to broadband communication system units 500.

FIG. 7A is a side view of a track lighting system showing three stock light fixtures 502 (but of a different type than illustrated in FIG. 1) and a broadband communication system 500 unit that appears and functions similarly to the stock lighting fixtures 502 according to a preferred embodiment of the present invention.

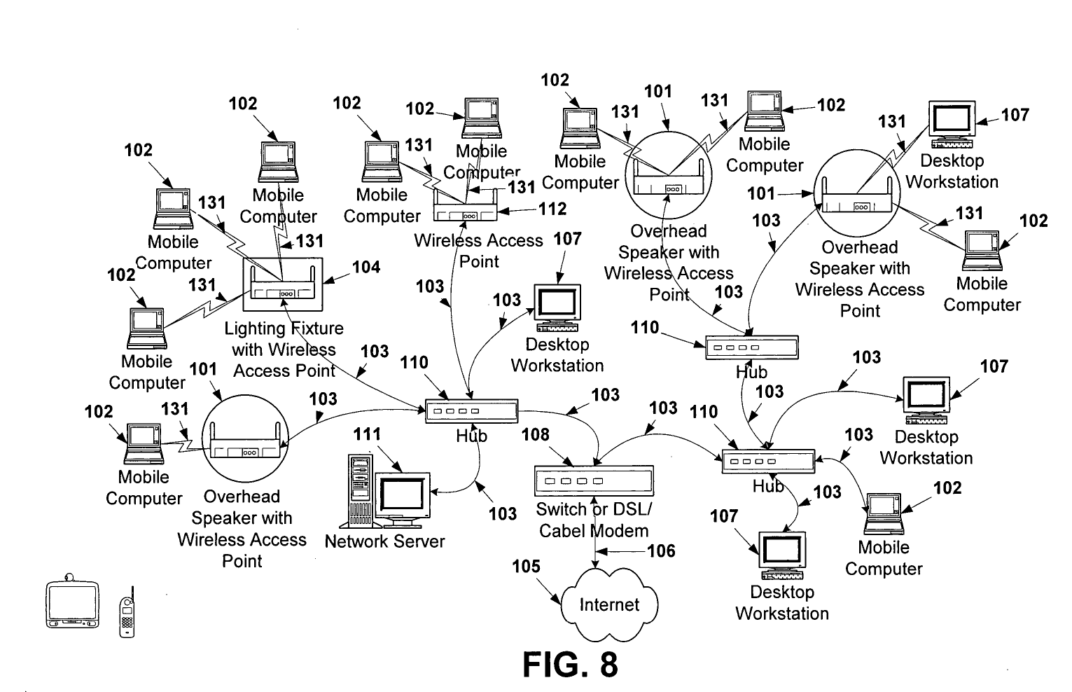

FIG. 8 is a simplified relational diagram of a preferred embodiment of the present invention, showing an example configuration of a broadband communication network. Preferably, mobile computers 102 are provided with wireless connections 131 by a broadband communication system such as a lighting fixture with a wireless access point 104 and/or an overhead speaker with a wireless access point 101, and/or another broadband communication system unit 500 that replaces a stock architectural element, etc. Preferably, broadband communication system 500 unit (such as a lighting fixture with wireless access point 104) is connected to a network server 111 and/or broadband source such as a cable modem or DSL connection, etc., connected to the Internet 105 as shown by connection 106. Hubs 110 may be used to connect elements of the network, such as the network server 111 to desktop workstations 107 and broadband communication system 500 unit via cables 103 (or through wireless connections, not shown). It is contemplated that broadband communication system 500 unit may supplement any type of network and may comprise any number and kind of elements and configurations, such as other types of connections of wireless access points 112 and electronic devices (such as printers, video cameras, video conferencing equipment, etc.). Upon reading the teachings of this specification, those with ordinary skill in the art will now understand that, under appropriate circumstances, considering such issues as the need for voice or video devices in the building, advancements in wireless technology, etc., mobile computers may take the form of other wireless devices, such as, for example, telephones, video conferencing units, PDA's (personal digital assistants), etc.

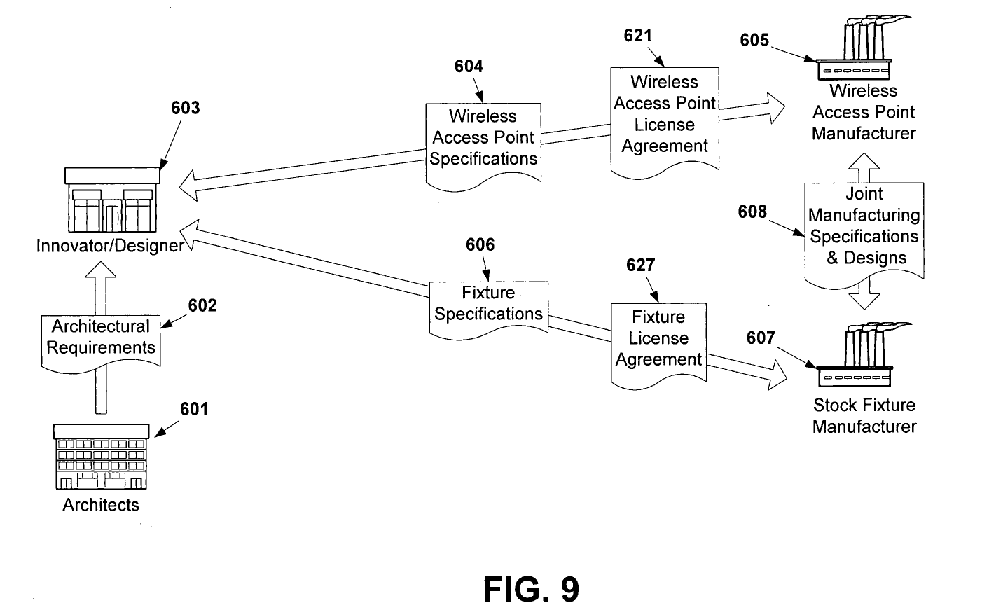

Referring to FIG. 9, according to a preferred embodiment of the present invention, innovator/designer 603 consults with architects 601 to identify the various architectural requirements 602 for combinations of stock fixtures, such as fluorescent lighting and overhead paging speakers, with wireless access points. Preferably, innovator/designer 603 will consider the architectural requirements 602 identified by the architects 601 and prepare a set of wireless access point specifications 604 to be used to identify and select a wireless access point manufacturer 605. Preferably, innovator/designer 603 will, additionally, consider the architectural requirements 602 identified by the architects 601 and prepare a set of fixture specifications 604 to be used to identify and select a stock fixture manufacturer 607. Preferably, innovator/designer 603 will negotiate a wireless access point license agreement 621 with a wireless access point manufacturer 605 for redesign of particular wireless access point models for operation in combination with other fixtures such as fluorescent lighting.

Likewise, preferably, innovator/designer 603 will negotiate a fixture license agreement 627 with the selected stock fixture manufacturer 607 for redesign of particular stock fixture models for operation in combination with the modified wireless access point. Preferably, both agreements will contain, at least, provisions for incorporating the modifications to the respective products to permit successful operation of each respective component and a basis for royalty payments to innovator/designer 603. Under appropriate circumstances, it may be preferable to complete a joint venture agreement amongst the parties to define additional aspects of the business relationships, such as profit sharing, marketing, naming conventions and other such pertinent considerations.

Preferably, innovator/designer 603, the selected wireless access point manufacturer 605 and stock fixture manufacturer 607 will cooperatively develop detailed joint manufacturing specifications and designs 608. Preferably, the joint manufacturing specifications and designs 608 ensure compatibility and operation both of the wireless access point and stock fixtures. Under appropriate circumstances, combinations of various wireless access point models and various models of stock fixture may be included in the joint manufacturing specifications and designs 608.

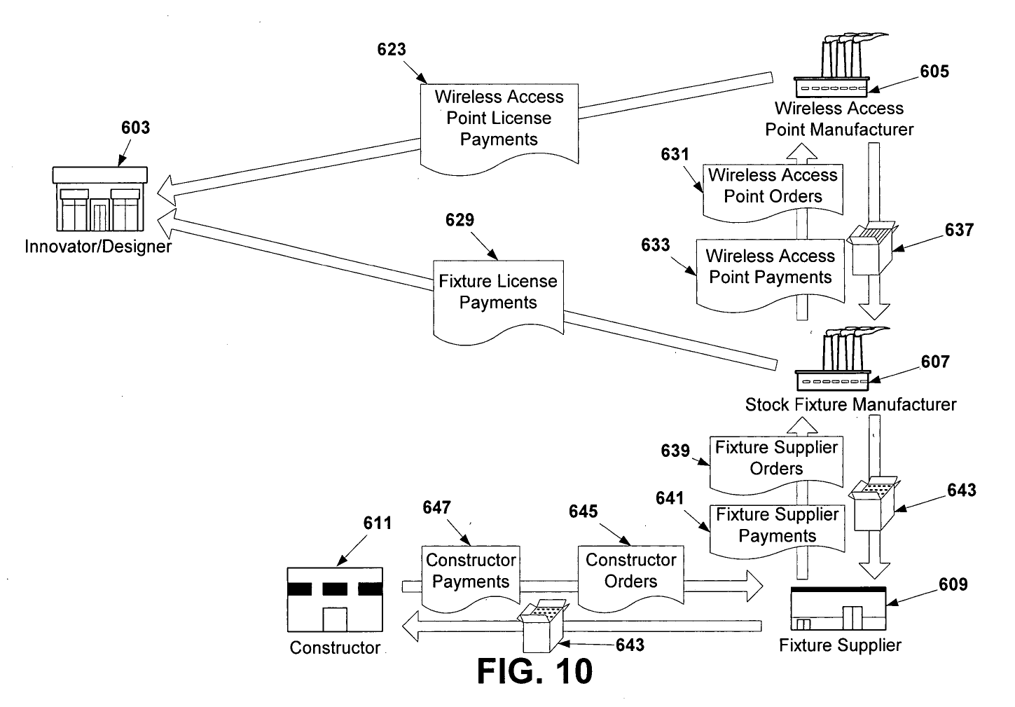

Referring to FIG. 10, preferably the selected wireless access point manufacturer 605 will agree to manufacture a modified wireless access point 637 with the necessary components and form to fit within the selected fixture of typical dimensions. Additionally, selected stock fixture manufacturer 607 will agree to manufacture stock lighting fixture with the necessary modifications and components to house the modified wireless access point. Preferably, the wireless access point manufacturer 605 will ship the modified wireless access points 637 or receive the appropriate purchasing orders 631 or similar documentation from the stock manufacturer 607. Payment will be made by the stock fixture manufacturer 607 to the wireless access point manufacturer 605 in the normal course of business in a manner acceptable to both the wireless access point manufacturer 605 and the stock fixture manufacturer 607. Additionally, preferably, the innovator/designer 603 will receive the agreed upon wireless access point license payments 623 for the number of units of modified wireless access point 637 shipped to the stock fixture manufacturer 607. After reading the teachings of this specification, those with ordinary skill in the art will appreciate that, under appropriate circumstances, considering such issues as the specific negotiated terms between the parties, etc., other methods and calculations of the wireless access point license payments 623 etc., may suffice.

Preferably, after receipt of the requested modified wireless access point 637, the stock fixture manufacturer 607 will assemble the modified wireless access point 637 and the modified stock fixture to produce the combo fixtures 643. Under appropriate circumstances, combo fixtures 643 may be comprised of various models of modified wireless access point and modified stock fixtures as may be necessary to satisfy fixture supplier and constructor requirements. Preferably, stock fixture manufacturer 607 will ship combo fixtures 643 to fixture supplier 609 on acceptance of fixture supplier orders 639. Preferably, in turn, payment will be made by the fixture supplier 609 to stock fixture manufacturer 607 in the normal course of business in a manner acceptable to both the fixture supplier 609 and the stock fixture manufacturer 607. Additionally, preferably, innovator/designer 603 will receive the agreed-upon fixture license payments 629 from stock fixture manufacturer 607 for the number of units of combo fixture 643 shipped to fixture supplier 609. Upon reading the teachings of this specification, those with ordinary skill in the art will appreciate that, under appropriate circumstances, considering such issues as the specific negotiated terms between the parties, etc., other methods and calculations of the fixture license payments 629 may suffice.

Stock fixture manufacturer 607 provides, preferably, a wide variety of stock fixtures to fixture supplier 609 who in turn provides them to constructor 611. Preferably, the various models of combo fixture 643 will be provided in the same manner. Preferably, constructor 611 will require combo fixtures 611 in the normal course of new construction and remodeling projects and place constructor orders 645 for combo fixtures 611 with fixture supplier 609. Preferably, fixture supplier 609 will ship combo fixtures 643 to constructor 611 on acceptance of constructor orders 645. Preferably, in turn, payment will be made by the constructor 611 to the fixture supplier 609 in the normal course of business in a manner acceptable to both the fixture supplier 609 and the constructor 611.

Thus, it is seen that this invention provides a method, related to providing a combined product related to use in a broadband communication system, related to locally supporting users with equipment having wireless communication ability in at least one area served by a plurality of similar-appearing stock fixtures, comprising the steps of: selecting an existing manufacturer of such similar-appearing stock fixtures; selecting an existing manufacturer of transceivers structured and arranged to assist wireless broadband communication; and assisting implementation of at least one joint development project, including both such existing manufacturer of such similar-appearing stock fixtures and such existing manufacturer of transceivers structured and arranged to assist wireless broadband communication, to provide combined product. And it further provides such method further comprising the step of using at least one at-least-partially-existing distribution channel of such existing manufacturer of such similar-appearing stock fixtures to distribute such combined product.

Although applicant has described applicant's preferred embodiments of this invention, it will be understood that the broadest scope of this invention includes such modifications as diverse shapes and sizes and materials. Such scope is limited only by the below claims as read in connection with the above specification.

Further, many other advantages of applicant's invention will be apparent to those skilled in the art from the above descriptions and the below claims.

What is claimed is:

1) A broadband communication system, relating to locally supporting users with equipment having wireless communication ability in at least one area served by a plurality of similar-appearing stock fixtures, comprising, in combination:
a) transceiver means for assisting wireless broadband communication by the users in the at least one area; and
b) concealer means for substantially concealing said transceiver means from the users in the at least one area;
c) wherein said concealer means comprises housing means for housing said transceiver means;
d) wherein said housing means comprises substantially stock fixture means for serving the at least one area; and
e) wherein said substantially stock fixture means comprises stock fixture subset means for providing at least one subset of the plurality of similar-appearing stock fixtures.

2) The broadband communication system according to claim 1 wherein said stock fixture means comprises lighting means for lighting the at least one area.

3) The broadband communication system according to claim 1 further comprising building means for providing the at least one area.

4) The broadband communication system according to claim 3 wherein said stock fixture means comprises lighting means for lighting the at least one area.

5) The broadband communication system according to claim 4 wherein said building means comprises network means for connection of said transceiver means with at least one network.

6) The broadband communication system according to claim 2 wherein said lighting means comprises at least one light bulb.

7) The broadband communication system according to claim 2 wherein said transceiver means is structured and arranged to fit within the space of a standard lighting-fixture ballast.

8) The broadband communication system according to claim 1 wherein said transceiver means comprises power means for drawing power from at least one power distribution network serving the plurality of similar-appearing stock fixtures.

9) The broadband communication system according to claim 1 further comprising display means for displaying transceiver status.

10) The broadband communication system according to claim 9 further comprising display adapter means for adapting said display means to be more easily seen.

11) The broadband communication system according to claim 1 wherein at least one single cable both carries data and provides power to said transceiver means.

12) A broadband communication system comprising, in combination:
a) at least one substantially stock lighting fixture; and
b) housed within said at least one substantially stock lighting fixture, at least one transceiver structured and arranged to assist wireless broadband communication;
c) wherein said broadband communication system is adapted to be connected to at least one source of electrical power and at least one communication network.

13) The broadband communication system according to claim 12 wherein said transceiver is adapted to fit within the space of a standard ballast.

14) The broadband communication system according to claim 12 wherein at least one single cable carries data and provides power to said at least one transceiver.

15) A method, related to providing a combined product related to use in a broadband communication system, related to locally supporting users with equipment having wireless communication ability in at least one area served by a plurality of similar-appearing stock fixtures, comprising the steps of:
a) selecting an existing manufacturer of such similar-appearing stock fixtures;
b) selecting an existing manufacturer of transceivers structured and arranged to assist wireless broadband communication; and
c) assisting implementation of at least one joint development project, including both such existing manufacturer of such similar-appearing stock fixtures and such existing manufacturer of transceivers structured and arranged to assist wireless broadband communication, to provide combined product.

16) The method according to claim 15 further comprising the step of using at least one at-least-partially-existing distribution channel of such existing manufacturer of such similar-appearing stock fixtures to distribute such combined product.

17) A broadband communication system, related to locally supporting users with equipment having wireless communication ability in at least one area served by a plurality of similar-appearing stock fixtures, comprising, in combination:
a) at least one transceiver to assist wireless broadband communication by the users in the at least one area; and
b) at least one concealer adapted to substantially conceal said at least one transceiver from the users in the at least one area;
c) wherein said at least one concealer comprises at least one housing to house said at least one transceiver;
d) wherein said at least one housing comprises at least one substantially stock fixture adapted to serve the at least one area; and
e) wherein said at least one substantially stock fixture comprises at least one subset of a plurality of similar-appearing stock fixtures.

18) The broadband communication system according to claim 17 wherein said at least one substantially stock fixture comprises at least one illuminator adapted to light the at least one area.

19) The broadband communication system according to claim 17 further comprising at least one building adapted to provide the at least one area.

20) The broadband communication system according to claim 19 wherein said at least one stock fixture comprises at least one illuminator adapted to light the at least one area.

21) The broadband communication system according to claim 20 wherein said at least one building comprises at least one network adapted to connect of said at least one transceiver within said at least one network.

22) The broadband communication system according to claim 18 wherein said at least one illuminator comprises at least one light bulb.

23) The broadband communication system according to claim 18 wherein said at least one transceiver is adapted to fit within the space of a standard lighting-fixture ballast.

24) The broadband communication system according to claim 17 wherein said at least one transceiver is adapted to draw power from at least one power distribution network of the plurality of similar-appearing stock fixtures.

25) The broadband communication system according to claim 17 further comprising at least one display adapter to permit ease of viewing of at least one display of transceiver status.

26) The broadband communication system according to claim 17 wherein at least one single cable both carries data and provides power to said at least one transceiver.

27) A communication system, related to locally supporting users with equipment having wireless communication ability in at least one area served by a plurality of similar-appearing stock fixtures, comprising, in combination:
a) transceiver means for assisting wireless communication by the users in the at least one area; and
b) concealer means for substantially concealing said transceiver means from the users in the at least one area;
c) wherein said concealer means comprises housing means for housing said transceiver means;
d) wherein said housing means comprises substantially stock fixture means for serving the at least one area; and
e) wherein said substantially stock fixture means comprises stock fixture subset means for providing at least one subset of the plurality of similar-appearing stock fixtures.
